(19) United States
(12) Patent Application Publication
(10) Pub. No.: US 2009/0043733 A1
(43) Pub. Date: Feb. 12, 2009

(54) SYSTEMS AND METHODS FOR EFFICIENTLY STORING, RETRIEVING AND QUERYING DATA STRUCTURES IN A RELATIONAL DATABASE SYSTEM

(75) Inventors: Douglas Kingsford, Auckland (NZ); Thomas Bakerman, North Shore City (NZ); Edward Costello, Auckland (NZ); Matthew Vincent, Auckland (NZ); John Welch, Auckland (NZ); Dennis Angelo, Auckland (NZ); Hau Lo, Auckland (NZ)

Correspondence Address: BAKER & MCKENZIE LLP;PATENT DEPARTMENT, 2001 ROSS AVENUE, SUITE 2300, DALLAS, TX, 75201, US

(73) Assignee: ORCHESTRAL DEVELOPMENTS LIMITED, Auckland (NZ)

(21) Appl. No.: 11/834,488

(22) Filed: Aug. 6, 2007

(51) Int. Cl. G06F 17/30; G06F 7/10

(52) U.S. Cl. 707/3; 707/101; 707/E17.002; 707/E17.014

(57) ABSTRACT

A database system is disclosed. The database system includes a common data repository, a document indexing database and a query engine. The common data repository is configured to store data in a common data table and is associated with a data object. The document indexing database is configured to store a data structure model that is associated with a unique document type. The data structure model is configured to facilitate retrieval of data stored in the common data table. The query engine is communicatively linked to the document indexing database and the common data repository. The query engine is configured to use the data structure model to retrieve data from the common data table.

### BACKGROUND

I. Field of the Invention

The present invention relates generally to indexing and searching electronic data records stored on a relational database, and more particularly to indexing data records so that they can be efficiently retrieved.

II. Background of the Invention

Companies and other professional organizations typically generate large amounts of information as a necessary byproduct of their operation. For example, an engineering firm may have a large number of employees that generate written specifications for buildings and systems, and a hospital could produce a large number of patient files, etc. These and other organizations store, process and organize large amounts of data (i.e., information) into various database systems.

The data in the database systems are typically stored in the form of data records, each composed of a fixed number of fields, also referred to as attributes. The fields of a record contain the data associated with that record. Frequently, database records are presented logically in the form of a table, with records as the rows of the table, and attributes as the columns. Database systems typically store records in memory and/or on disk or other media as a linked list, with data for each record stored together into common data tables. However, the data for adjacent records or even adjacent values of the same field are not necessarily stored in any particular proximity or order.

The manner in which the data is stored and indexed presents inherent limitations on the data record search (i.e., query) and/or retrieval performance of database systems. Processing of search and/or retrieval requests frequently takes a significant amount of time and database system resources. As such, there is a need for an efficient way to index data records so that they may be quickly and efficiently retrieved during a data query call.

### SUMMARY

Systems and methods for indexing and querying data records stored in a relational database system are disclosed.

In one aspect, a computer implemented method for indexing a document on a database is disclosed. A unique identifier is created for the document. An entry is added to a document instance table, wherein the entry includes the unique identifier and an attribute associated with the document. The document type for the document is identified. A data structure model associated with the identified document type is retrieved from a document indexing database. The document is parsed into data segments that correspond to objects specified by the data structure model. Common data tables associated with each of the specified objects are identified, wherein the common data tables are stored in a common data repository. The data segments are inserted into the common data tables associated with the specified objects that the data segments correspond to. The data segments include the unique identifier for the document, a path to the specified object, and a unique object instance identifier.

In a different aspect, a computer implemented method for retrieving a document from a database is disclosed. The document is located on a document instance table using a attribute value associated with the document. A document structure model associated with the identified document type, for the document, is retrieved. Common data tables corresponding to objects specified by the data structure model of the document are identified. The data segments that share the same unique identifier as the documents are retrieved from the identified common data tables. The document is reconstructed with the retrieved data segments. The data segments are positioned within the document using path attribute values of the retrieved data segments and the data structure of the document.

In another aspect, a computer implemented method for retrieving data segments from a database is disclosed. An object containing the data segments to be retrieved are identified using a data structure model stored in a document indexing database. A portion of a path to the identified object is determined using the data structure model. A common data table corresponding to the identified object is identified. Data segments from the identified common data table with path attribute values that contain the determined path portion are retrieved.

In still another aspect, a computer implemented method for searching a database is disclosed. A first object containing a first field and a second object containing a second field to be retrieved is identified using a data structure model stored in a document indexing database. A portion of the first path to the first object and a portion of a second path to the second object is determined using the data structure model. Common data tables corresponding to the identified first object and the identified second object are identified. Data segments from the identified common data tables with path attribute values that contain the first path portion and the second path portion are identified. A join between the identified first data segment and the identified second data segment within each of the identified common data tables is performed. The identified data segments are returned.

In still yet another embodiment, a database system is disclosed. The database system includes a common data repository, a document indexing database and a query engine. The common data repository is configured to store data in a common data table and is associated with a data object. The document indexing database is configured to store a data structure model that is associated with a unique document type. The data structure model is configured to facilitate retrieval of data stored in the common data table. The query engine is communicatively linked to the document indexing database and the common data repository. The query engine is configured to use the data structure model to retrieve data from the common data table.

These and other features, aspects, and embodiments of the invention are described below in the section entitled “Detailed Description.”

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is an illustration of a database management system (DBMS) design configuration for efficient indexing and querying of data records, in accordance with one embodiment.

FIG. 2 is an illustration of the inter-relationships between an information model, a data container model and a physical document type, in accordance with one embodiment.

FIG. 3A is an illustration of how multiple data objects in a data container model can be related to a single data object, in accordance with one embodiment.

FIG. 3B is an illustration of a physical document representation that has been abstracted to match the data container model for a document type, in accordance with one embodiment.

FIG. 3C is an illustration that depicts how parent object tables for each data object can be utilized to allow efficient complex queries of data from those data objects, in accordance with one embodiment.

FIG. 4 is an illustration that depicts how attribute values of document instances, data objects and parent object tables can be used to define the inter-relationships between them, in accordance with one embodiment.

FIG. 5 is a flow chart illustrating an example process for indexing a document, in accordance with one embodiment.

FIG. 6 is a flow chart illustrating an example process for retrieving a document, in accordance with one embodiment.

FIG. 7 is a flow chart illustrating an example process for retrieving data segments from a database, in accordance with one embodiment.

FIG. 8 is a flow chart illustrating an example process for querying a database, in accordance with one embodiment.

### DETAILED DESCRIPTION

Systems and methods for indexing and querying data records stored in a relational database system are disclosed. It will be clear, however, that the present invention may be practiced without some or all of these specific details. In other instances, well known process operations have not been described in detail in order not to unnecessarily obscure the present invention.

As used herein, a database may be any collection of records or information which is stored in a conventional computing device in a systematic (i.e. structured) way so that a user can consult it to answer queries. Examples of the types of data structures that are used by databases to store information include: arrays, lists, trees, graphs, etc.

A database storage device can be any conventional computing device (e.g., server, mainframe, etc.) that is used to store one or more databases. Database storage devices can be of any make (e.g., Sun Microsystems Inc., IBM, Dell, Compaq, Hewlett Packard, etc.) running on any database protocol (e.g., Oracle, Sybase, etc.). A database network system can be any client/server network that contains one or more linked network database storage devices (i.e., database servers) configured to be accessed as a data resource by one or more client devices (e.g., mobile phone, laptop, GPS positioning device, etc.).

A schema is a logical construct that is used to define a class of software objects (i.e., an object can be an instantiation (implementation) of a class). A schema may be structured to include elements, sub-elements and attributes. Elements that include data containing sub-elements and/or attributes are termed as complex data type whereas elements that include data in the form of only numbers or character strings are termed as simple type. In one embodiment, the schema is created using Extensible Markup Language (XML). In another embodiment, the schema is created using JAVA™. It should be understood, however, that a schema can be created using any programming language so long as the schema can be utilized to instantiate a class of software objects (i.e., instances).

Object-relational mapping (ORM) is a technique for converting data between incompatible type systems in databases, in effect, creating a “virtual object database.” Using this technique, data can be represented as an object value but stored in one or more relational database tables. Data management tasks in object-oriented (OO) programming are typically implemented by manipulating the objects. Dedicated database management software can be used to convert the object values into groups of simpler values for storage in the relational database (and convert them back upon retrieval). That is, translate those objects to forms which can be stored in the relational database, and which can later be retrieved, while preserving the properties of the objects and their relationships.

Using the example of an address book where each address book entry represents a single person along with zero or more phone numbers and zero or more addresses. This could be modeled in an object-oriented implementation by a “person object” with “slots” to hold the data that comprise the entry: the person's name, a list (or array) of phone numbers, and a list of addresses. The list of phone numbers would itself contain “phone number objects” and so on. The address book entry is treated as a single value by the programming language (it can be referenced by a single variable, for instance). Various methods can then be associated with the object, such as a method to return the preferred phone number, the home address, and so on.

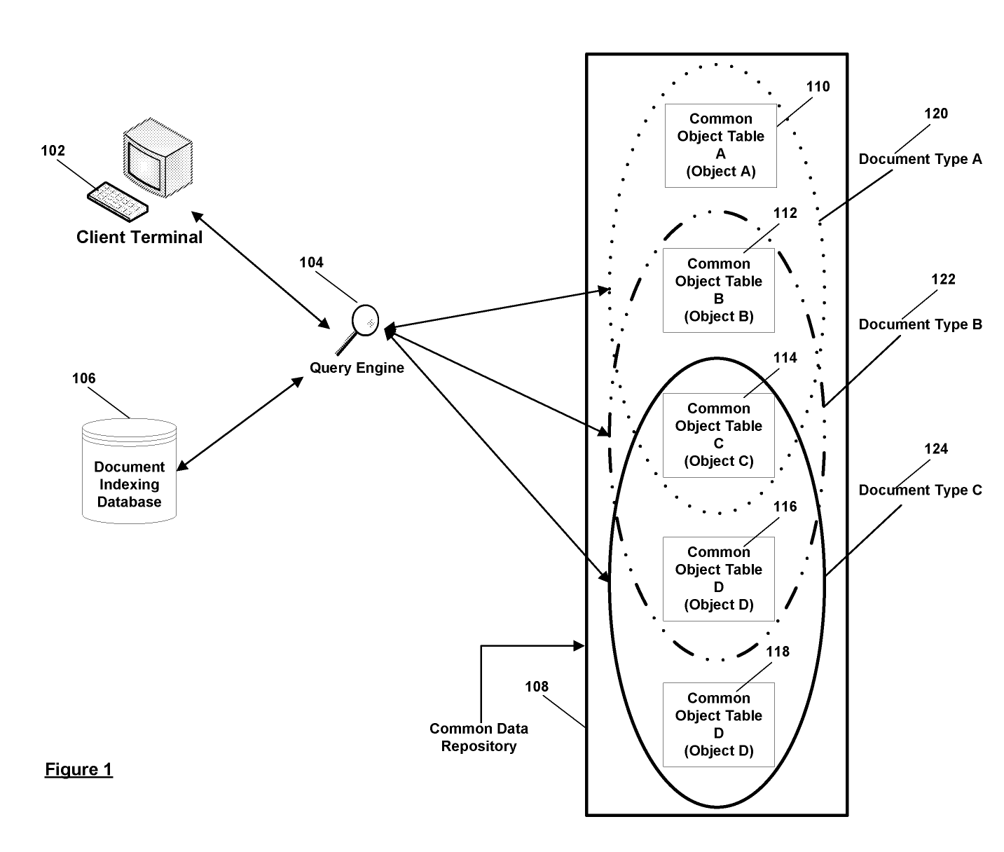

FIG. 1 is an illustration of a database management system (DBMS) design configuration for efficient indexing and querying of data records, in accordance with one embodiment. As depicted, herein, the DBMS includes a client interface 102, a query engine 104, a document indexing database 106 and a common data repository 108. In one embodiment, the client interface 102 is a terminal display configured to display responses and facilitate the specification of queries, insertions and or updates. In another embodiment, the client interface 102 is a separate application configured to specify queries, insertions, updates and/or process responses.

The client interface 102 is communicatively connected with the query engine 104, document indexing database 106, and common data repository 108. The client interface 102 can be a conventional “thin-client” or “thick client” computing device configured to utilize a variety of network interfaces (e.g., web browser, CITRIX™, WINDOWS TERMINAL SERVICES™, telnet, or other equivalent thin-client terminal applications, etc.) to input, modify, retrieve and/or display data records from the common data repository 108 and data structure models from the document indexing database 106. Additionally, the client interface 102 can be configured to access and configure the configuration files that define the operational settings of the query engine 104, common data repository 108, and the document indexing database 106. In one embodiment, the client interface 102 and the query engine 104 are part of the same computing device. For example, the client interface 102 may be a thick-client terminal that is configured to implement the query engine 104. In another embodiment, the client interface 102 and the query engine 104 are implemented on separate computing devices. For example, the client interface 102 may be a thin-client terminal that is used to access the query engine 104 that is implemented as part of a computing mainframe or server.

The document indexing database 106 is communicatively connected with the client interface 102 and the query engine 104. The document indexing database 106 is configured to store a document instance table and one or more data structure models that can be used to define the data structure (in a data container model) of a document and/or the semantics (meaning) of the data itself (in an information model). That is, the document indexing database 106 stores data structure models that can be characterized as a data container model or an information model. Inclusive as a component of the data container model and/or the information model is a parent object table. Typically, the data structure models are created within the relational database management system (RDBMS) construct using structured query language (SQL). The SQL commands may be delivered to the database storage device (e.g., server, mainframe, etc.) by a variety of means such as an Open Database Connectivity (ODBC) or JAVA Database Connectivity (JDBC) connections.

The data container model can convey structural information about how data is organized and presented in a physical document (e.g., document, form, message, etc.). That is, the data container model depicts a data object structure that can be used to map out the paths to the data objects representing the various data sections, sub-sections, and fields in the document. For example, the data container model for an employment application document may depict paths to the data objects representing the sections (e.g., contact information, skills, prior employment history, educational background, etc.), sub-sections (e.g., for the contact information section: home address, mailing address, phone numbers, e-mail address, etc), and fields (e.g., for the phone numbers sub-section: daytime phone number, evening phone number, mobile phone number, etc.) of the document. Thus, a path to the daytime phone number may start at the resume document and proceed to the contact information section data object followed by the phone numbers subsection data object and on to the daytime phone number field data object. In one embodiment, each physical document type stored in the document indexing database 106 is associated with a unique data container model. In another embodiment, a data container model can be associated with a plurality of physical document types that have identical data structures

The parent object table can be used to relate data stored in one or more data objects to facilitate complex query functions. The parent object table can be associated with any data objects, within the data container, that are contained in one or more other data objects. For example, an home address data object containing home address information can be contained in a care giver information object, a patient information object and a doctor information object. That is, the home address data object may contain the home address information for the care giver, the patient and the doctor. So the parent object table relates the data stored in the home address data object with the data stored in the care giver information object, the patient information object, and the doctor information object. This facilitates the queries for the home address information by person type (i.e., patient, care giver, doctor).

The information model can convey the semantics of the various data objects, define how the data objects relate in the real world, and/or establish the relationships between the various data objects themselves. The semantic information can provide information about the data type stored in the data objects and can link different data objects that share data type commonalties. For example, patient phone numbers can be stored in different phone number data objects that are associated with a patient record or a patient billing statement. The information model, therefore, can provide a means to semantically search for patient phone numbers by providing a “link” between the data type (i.e., patient phone numbers) and the data objects representing the storage of patient phone numbers (i.e., the patient phone number objects in the patient record and the patient billing statement). Using another example, the link (e.g., that the “blood pressure” field on the clinical trial data collection form means the “blood pressure” property of the patient's arm) is accomplished by associating the data objects (i.e., “blood pressure” field on a clinical trial data collection form, contained within a “cardiovascular examination” section, in turn contained within a “patient assessment” section) in a data container model with the corresponding semantic (e.g., “blood pressure” is a property of “arm”, which is a component of “patient”) objects of an information model that define the meaning of the data stored in the data objects.

The document instance table identifies all document instances stored in the repository by assigning each a unique identifier and recording one or more attributes (such as author) that are relevant to each document instance as a whole. These attributes are typically used for search purposes in addition to document display. The document instance unique identifiers are then used in the data object tables to record which particular document instance each data object instance belongs to.

By indexing data using a data container model, information model, document instance table, and/or parent object table, relatively complex data queries can be executed with relative ease and efficiency. Examples of how this indexing scheme can be used include, but are not limited to: 1. retrieval of a fragment of an object, from a single field, cluster of fields or document section right up to an entire document instance (e.g., a blood pressure, a list of medication orders contained within a clinic note section or an entire patient history document), 2. querying arbitrary component(s) of the data objects and reporting either within the scope of an individual data record instance or data record populations (such as retrieving the identity of all patients with diabetes mellitus complicated by renal impairment and BP greater than 140/90), and 3. reporting of all data with the same meaning, irrespective of which type of document it was captured in (such as all blood pressures, whether is was captured in a patient referral document, disease management workflow form, clinical trial data collection form, etc.).

The common data repository 108 is communicatively connected with the query engine 104 and is configured to store data in common data tables (i.e., Common Data Table “A” 110, Common Data Table “B” 112, Common Data Table “C” 114, Common Data Table “D” 116, and Common Data Table “E” 118), each of which is associated with a data object (i.e., Object “A”, Object “B”, Object “C”, Object “D”, and Object “E”). For example, a common data table for storing home addresses can be associated with a data object or data object instance for home address. Common data tables are typically arranged into rows and columns, wherein, each row of the common data table can represent a separate data entry and each column can represent one or more attributes of the data entry. For example, a row can represent a particular patient “Joe Smith,” column 1 can be a document instance identification number for the document instance containing the home address information relating to Joe Smith, column 2 can be unique object instance identification number for Joe Smith and column 3 can be a time stamp associated with the Joe Smith data entry.

In one embodiment, the common data repository 108 and document indexing database 106 resides on the same computing device (e.g., computer, server, mainframe, etc.). In another embodiment, the common data repository 108 and document indexing database 106 resides in separate computing devices. In yet another embodiment, the common data repository 108 resides in a plurality of distributed computing devices.

The query engine 104 is communicatively connected to the client terminal 102, the document indexing database, and the common data repository. The query engine 104 is configured to retrieve a document structure model (i.e., data container model and/or information model) from the document indexing database 106 prior to indexing or retrieving data from the common data repository 108. The document structure model can be used to map each section, sub-section, or field of a document type to a common object table. That is, various groupings of common data tables, together, stores information for a particular document type (i.e., Document Type “A” 120 is comprised of Common Data Table “A” 110, Common Data Table “B” 112, Common Data Table “C” 114; Document Type “B” 122 is comprised of Common Data Table “B” 110, Common Data Table “C” 112, Common Data Table “D” 114; and Document Type “C” 124 is comprised of Common Data Table “C” 114, Common Data Table “D” 116, Common Data Table “E” 118).

In particular, the data container model presents the various sections, sub-sections, or fields of a document type as data objects. Since each data object is associated with a particular common data table stored in the common data repository 108, the data container model can be used to direct data stored in the each instance of a particular document type to the correct common object table for storage and later retrieval.

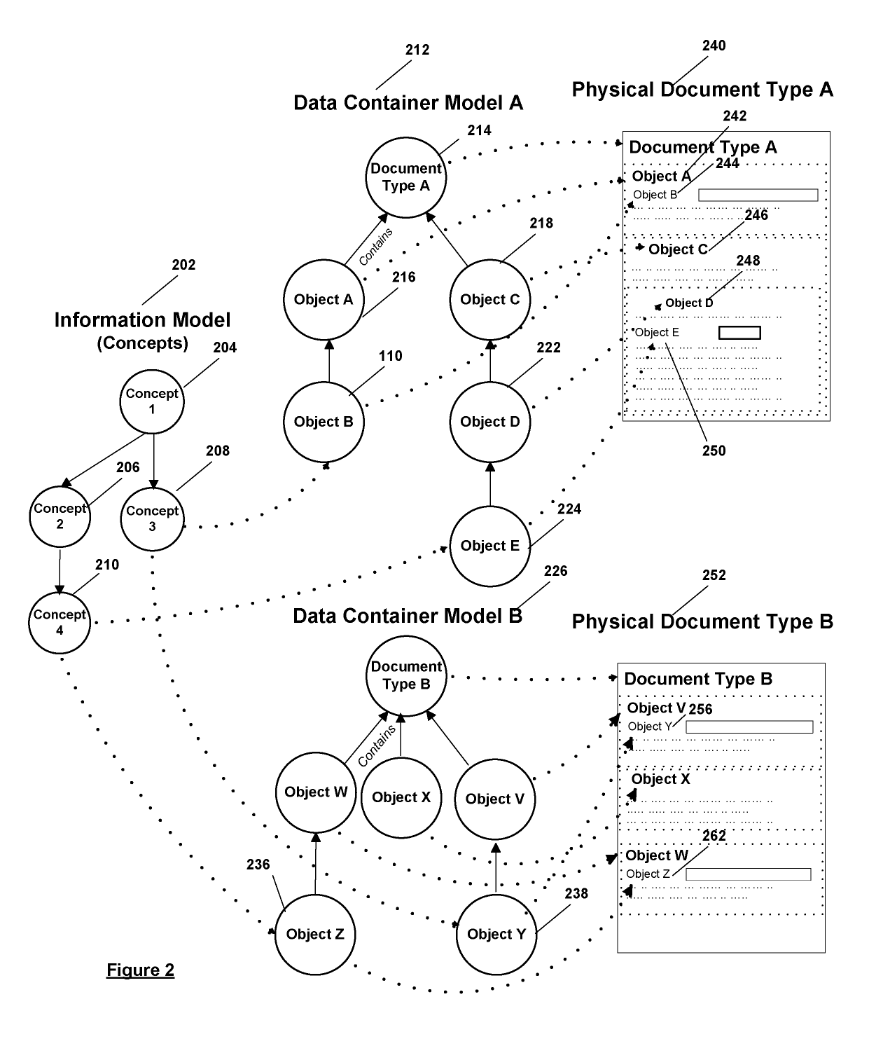

FIG. 2 is an illustration of the inter-relationships between an information model, a data container model and a physical document type, in accordance with one embodiment. As shown, herein, an information model 202 is used to relate a number of inter-related concepts to impart meaning to data stored in a data object. For example, Concept “4” 210 could be “blood pressure”, a property of Concept “2” 206 (which could be “arm”) which is a component of Concept “1” 204 (which could be “patient”). Thus, the information model 202 imparts meaning to the concept of blood pressure. Data container models can use structural objects to define the physical structure of the sections, sub-sections and fields of a document. For example, the data container model “A” 212 depicts document type “A” 214 containing Object “A” 216 and Object “C” 218. Object “A” 216 in turn contains Object “B” 220. Object “C” 218 contains Object “D” 222, which contains Object “E” 224. Each object in the data container model (for document type “A”) corresponds to a section, sub-section or field in the physical document type “A” 240. For example, Object “A” 216 (on data container model “A” 212) corresponds to Object “A” 242 (on physical document type “A” 240), Object “B” 220 (on data container model “A” 212) corresponds to Object “B” 244 (on physical document type “A” 240), Object “C” 218 (on data container model “A” 212) corresponds to Object “C” 246 (on physical document type “A” 240), Object “D” 222 (on data container model “A” 212) corresponds to Object “D” 248 (on physical document type “A” 240), and Object “E” 224 (on data container model “A” 212) corresponds to Object “E” 250 (on physical document type “A” 240).

Each of the concepts (i.e., Concept “1” 204, Concept “2” 206, Concept “3” 208, Concept “4” 210) represented in information model 202 can be linked to zero or more data objects (in one or more data container models) that contain data with the same meaning. For example, Concept “4” 210 can be linked to Object “E” (in data container model “A” 240) and Object “Z” 236 (in data container model “B” 226), and Concept “3” 208 can be linked to Object “B” 220 (in data container model “A” 240) and Object “Y” 238 (in data container model “B” 252). Using this scheme, data represented by the information model can be stored in multiple different data objects in one or more document types.

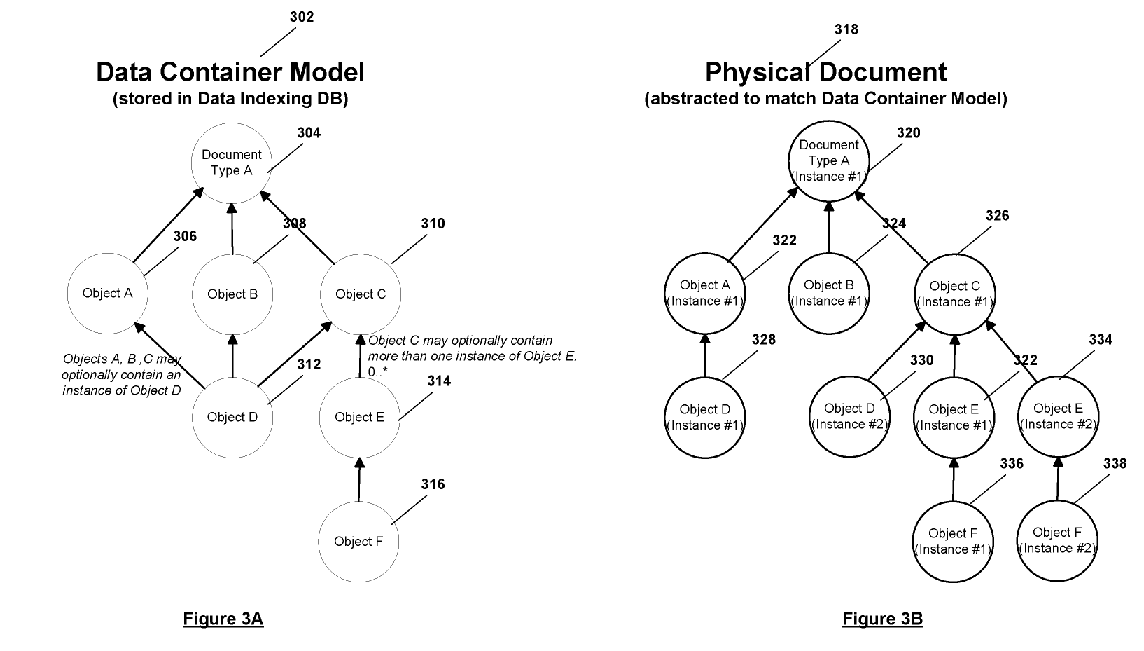

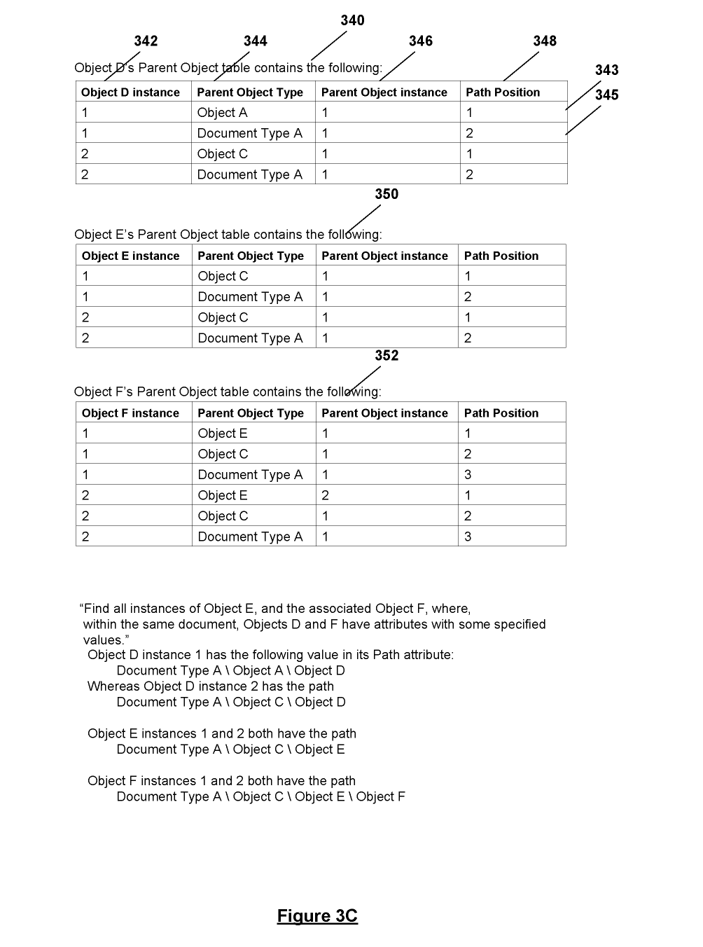

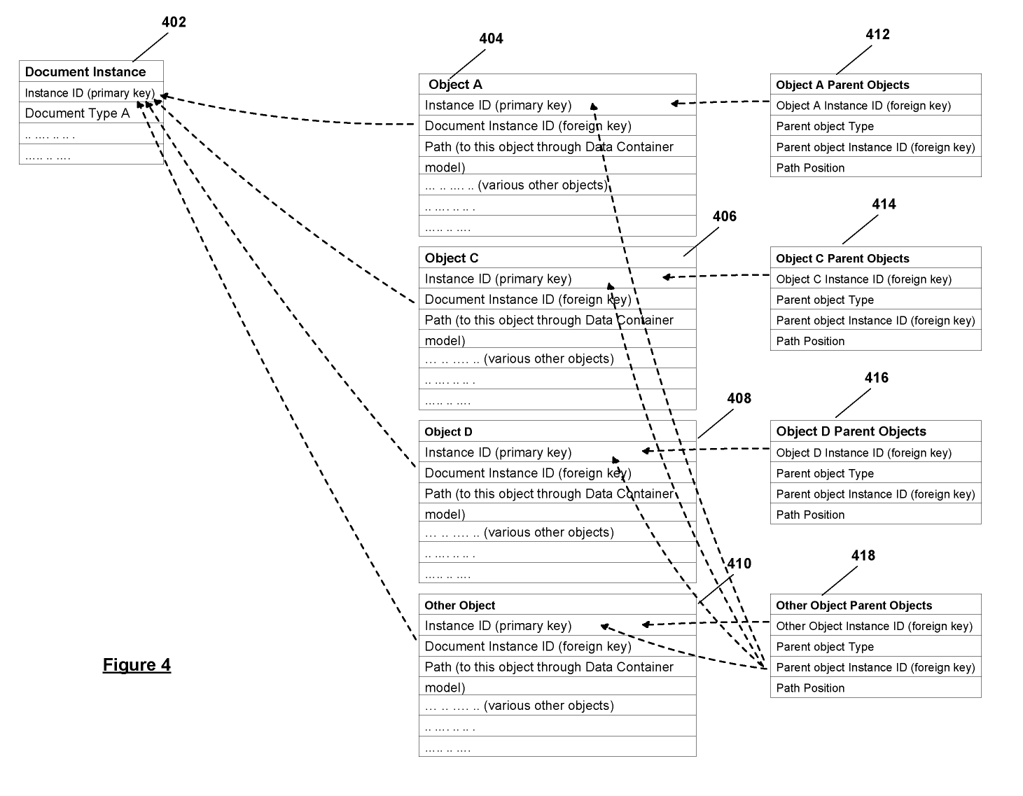

FIG. 3A-3C depicts how a parent object table can be used allow for efficient complex queries of data, in accordance with certain embodiments. FIG. 3A is an illustration of how multiple data objects in a data container model 302 can be related to a single data object, in accordance with one embodiment. As shown, herein, document type “A” 304 contains Data Object “A” 306, Data Object “B” 308, and Data Object “C” 310. Those objects (i.e., Data Object “A” 306, Data Object “B” 308, and Data Object “C” 310) in turn optionally contain an instance of Data Object “D” 312. Data Object “C” 310 may optionally contain more than one instance of Data Object “E” 314, which in turn contains Data Object “F” 316.

In FIG. 3B, a physical document representation 318 has been abstracted to match the data container model 302 for document type A 304, in accordance with one embodiment. This abstraction depicts how the various instances of the data objects represented in the data container model 302 are logically related to one another on a physical document. Document type “A” 320, therefore, contains a first instance of Data Object “A” 322, Data Object “B” 324 and Data Object “C” 326. Data Object “A” 322 contains a first instance of Data Object “D” 328. Data Object “C” 326 contains a second instance of Data Object “D” 330, a first instance of Data Object “E” 332, and a second instance of Data Object “E” 334. The first instance of Data Object “E” 332 contains a first instance of Data Object “F” 336 while a second instance of Data Object “E” 334 contains a second instance of Data Object “F” 338.

FIG. 3C depicts how parent object tables for each data object can be utilized to allow efficient complex queries of data from those data objects, in accordance with one embodiment. As shown, herein, the Data Object “D” Parent Object Table 340 contains columns for the Object “D” Instance 342, Parent Object Type 344, Parent Object Instance 346, and Path Position 348. Each column depicts a particular attribute of the object instances of Data Object “D”. The Data Object “D” Parent Object Table 340 can be use to identify the path attribute for each object instance of Data Object “D”.

The Object “D” Instance 342 column identifies the particular object instance of Data Object “D”. Each object instance is unique to a data entry stored in Data Object “D”. For example, a first instance of a home address information data object can store a patient's home address information, a second instance of the home address information data object can store a doctor's home address information, and a third instance of the home address information data object can store a care giver's home address information. In one embodiment, the data referenced in instances of the same data object are associated in the same common data table of a common data repository. In another embodiment, the data referenced in the instances of the same data object are stored in a plurality of common data tables of a common data repository.

The Parent Object Type 344 column denotes the type of parent object that the particular object instance of Data Object “D,” indicated on the left in the Object “D” Instance 342 column, is contained in. The Parent Object Instance 346 identifies the particular instance of the parent object type and the Path Position 348 denotes the position on the path that the parent object is located. For example, a first object instance of Data Object “D” 343 can be contained in a first object instance of Data Object “A” which in turn is in path position “1” that denotes the nearest position to the first object instance of Data Object “D”. The second object instance of Data Object “D” can be contained in a first object instance of Document Type “A” which in turn is in path position “2” that denotes the next closest position to the first object instance of Data Object “D”. In short, the first object instance of Data Object “D” has the following value in its path attribute: Document Type A\ Data Object A\ Data Object D. Using the attributes described in the Data Object “D” Parent Object Table 340 for the second object instance of Data Object “D,” the path attribute for the second object instance of Data Object “D” has the following value: Document Type A\ Data Object C\ Data Object D.

Applying the discussion above with respect to the Data Object “D” Parent Object Tables 340, Data Object “E” Parent Object Table 350 shows that the first and second object instances of Data Object “E” has a path value of: Document Type A\ Data Object C\ Data Object E. Data Object “F” Parent Object Table 352 shows that the first and second object instance of Data Object “F” has a path value of: Document Type A\ Data Object C\ Data Object E\ Data Object F.

It should be appreciated, however, that this is but just one example of how a parent object table may be configured. In practice, the parent object table may include more or less columns (attributes) of information depending on the particular construct of the database management system and the nature of the complex queries required to be executed on the particular database. For example, certain embodiments of the parent object table may not require a column for Path Position 348 as the particular implementation of the complex query may not require that information.

The parent object tables for the various data objects mapped out in the data container for document type “A” allows the following types of queries:
1. A query for instances of Data Object “D” where the path to that object in a given document is Document Type A \ Data Object C \ Data Object D.
2. A query for instances of Data Object F where the path to that object in a given document is Document Type A \ Data Object C \ Data Object E \ Data Object F.
3. A query that constrains the result by restricting those table rows identified as meeting requirements in queries 1 and 2 above and having certain other required attribute values.
4. A query for instances where Data Objects D and F are related and where the Data Object D instance has an immediate parent (i.e., Path Position=1) that is Data Object C and has the same instance identification number as a parent of the Data Object F instance that is also of type Data Object C and is the second closest parent to the Data Object F instance (i.e., Path Position=2). This allows the determination that the constraints specified in queries 1, 2 and 3 above occurred concurrently within the same instance of Object C.
5. A query for instances of Data Object C containing two instances of Data Object E and two instances of Data Object F. In addition to the capability described in query 4 above, this table also allows the determination of which instance of Data Object E is associated with which instance of Data Object F.

It should be understood, however, that these are just several example of types of complex data queries that can be efficiently executed using the information contained in the parent object tables and that essentially any type of complex query is possible as long as the data object to data object relationships described in the query can be represented in the parent object table.

FIG. 4 is an illustration that depicts how the attribute value of document instances, data objects and parent object tables can be used to define the inter-relationships between them, in accordance with one embodiment. As shown, herein, a document instance 402 is associated with Object “A” 404, Object “C” 406, Object “D” 408, and “Other” Object 410. The document instance 402 has attributes such as a unique document instance ID (primary key) and the document type (i.e., Document Type “A”) associated with the document instance 402. All the objects associated with document instance 402 in turn have their own unique object instance ID (foreign key) and one or more associated attributes (e.g., document instance ID, path value, etc.). Each of the objects are in turn associated with parent objects (i.e., Object “A” Parent Objects 412, Object “B” Parent Objects 414, Object “C” Parent Objects, Object “D” Parent Objects 418, etc.). The parent objects each have their own unique parent object instance ID (foreign key) and one or more associated attributes (e.g., instance ID of the object associated with the parent object, parent object type, ordinal number, etc.).

Each instance of an object type receives a unique instance ID., referred to in RDBMS systems as the “primary key”. When one object refers to another object (such as where one object is said to be the parent of another object), references to such a specified object can be made by way of stating its primary key. This is referred to as the “foreign key”. For example, if there is a need to record in the Object “A” Parent Objects Table that Object “B” is a parent of Object “A”, a row can be inserted containing the Object “A” instance ID as a foreign key (i.e., the primary key of the instance of Object “A” in the Object “A” table) and also the instance ID for Object “B” as a foreign key (i.e., the primary key of the instance of Object “B” in the Object “B” table, in this example as the parent object instance ID in the Parent Objects table).

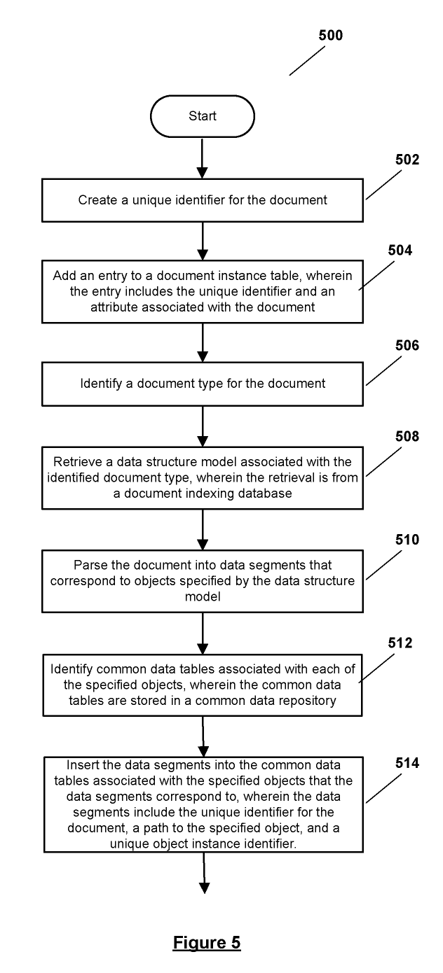

FIG. 5 is a flow chart illustrating an example process for indexing a document, in accordance with one embodiment. As depicted, herein, method 500 begins with step 502 where a unique identifier is created for the document being indexed. The unique identifier may be any string of alphanumeric character, symbols or combination thereof. The method proceeds on to step 504 where an entry is added to a document instance table. The entry includes the unique identifier for the document and an attribute (e.g., author, date submitted, intended audience, etc.) that this associated with the document. The method moves on to step 506 where a document type (e.g., patient referral document, disease management workflow form, clinical trial data collection form, etc.) is identified.

Once the document type is identified, method continues on to step 508 where a data structure model associated with the identified document type is retrieved from the document indexing database. In one embodiment, the data structure model is a data container model for the identified document type. In another embodiment, the data structure model is an information model associated with the identified document type. It should be appreciated that more than one data structure model can be retrieved for each identified document type. That is, each document type can be associated with combinations of different types of data structure models (i.e., data container model, information model) depending on the complexity of the inter-relationships between the various data objects that comprise the document.

In step 510, the data depicted in the document is parsed into data segments that correspond to the various data objects that are specified in the data structure model associated with the document. For example, the data container model of a resume document can include data objects for the educational background section, professional work history section, contacts section, professional development section, and hobbies section of the document. Data stored in the various sections (i.e., educational background, professional work history, contacts, professional development, hobbies) of the resume document are parsed and corresponded to the data objects associated with the sections of the resume document. For example, education data stored in the educational background section of the resume document is corresponded to the educational background data object associated with the educational background section for storage.

In step 512, the common data tables associated with each of the specified data objects, from step 510, are identified. The common data tables are typically stored in a common data repository.

Method 500 proceeds to step 514, where the parsed data segments, from step 510, are inserted into the common data tables associated with the data objects that the parsed data segments are corresponded to. For example, education data from the resume document is stored in the common data table that is associated with the educational background data object that the data corresponds to. In addition to educational background information, the education data includes other attributes such as a unique document instance ID, a path to the educational background data object, and a unique object instance ID. It should be understood, however, that these are just examples of some types of attributes that may be included and is not meant to limit the various embodiments of the present invention. In certain embodiments, the values of certain attributes may be used as a source of constraint for data querying purposes. Examples of constraint attributes may include, but are not limited to: gender, age, occupation, the presence of a specified medical condition, etc. By way of example, this can be used to apply a query to a medical database to retrieve all male patients over 50 years of age that have diabetes mellitus and blood pressure greater than 140/90 mmHg.

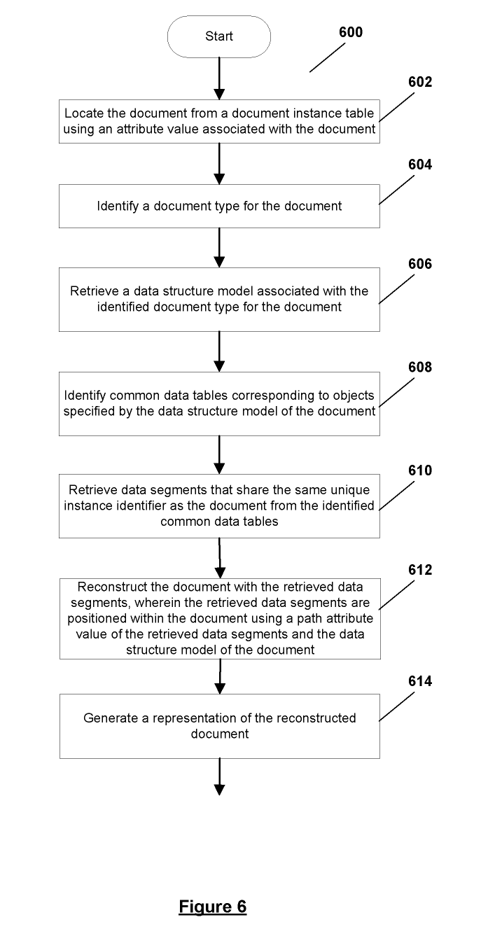

FIG. 6 is a flow chart illustrating an example process for retrieving a document, in accordance with one embodiment. The method 600 begins with step 602 where the document is located from a document instance table using an attribute value associated with the document. In one embodiment, the attribute value is a unique document instance ID (i.e., unique identifier) for the document. For example, a resume document with a document instance ID of 001. In another embodiment, the attribute value is a time stamp value associated with the document. For example, a court filing that has a time stamp of 12:00 PM. It should be understood, however, that the attribute value can be any characteristic of the document that can be used by the query engine to differentiate the document from other documents also stored in the document instance table.

Method 600 proceeds to step 604 where a document type (e.g., patient referral document, disease management workflow form, clinical trial data collection form, etc.) is identified.

Once the document type is identified, method continues on to step 606 where a data structure model associated with the identified document type is retrieved from the document indexing database. In one embodiment, the data structure model is a data container model for the identified document type. In another embodiment, the data structure model is an information model associated with the identified document type. It should be appreciated that more than one data structure models can be retrieved for each identified document type. That is, each document type can be associated with combinations of different types of data structure models (i.e., data container model, information model) depending on the complexity of the inter-relationships between the various data objects that comprise the document.

Method 600 moves on to step 608 where the common data tables associated with each of the data objects specified in the retrieved data structure model, from step 604, are identified. The common data tables are typically stored in a common data repository.

Method 600 continues on to step 610 where data segments that share the same unique document instance ID as the document are retrieved from the identified common data tables. For example, where a resume document being retrieved has a document instance ID of 001, data segments that have attributes containing the document instance ID of 001 would be retrieved from the identified common object tables.

In step 612, the document is reconstructed using the retrieved data segments. The data segments are positioned within the reconstructed document using path attribute values associated with each of the retrieved data segments and a data structure model (i.e., data container, information model, and/or parent object table) of the document. That is, since documents are hierarchical in structure, an object A whose path attribute is wholly contained within the path attribute of another (object B) must be closer to the document root than object B. This provides a basis for sorting all objects into an appropriate order, from which a hierarchy can be readily determined (a hierarchy is formed when one object has one or more child object, but each child object has at most one parent object). Further complexity occurs when more than one instance of a particular object type is permitted as a child of another object type (as is the case with Object E in FIG. 3A). In FIGS. 3A and 3B, the aforementioned sort reveals that the set of instances of Object E (332 and 334) are immediate parents of the set of instances of Object F (336 and 338), but it is necessary to inspect the Parent Object Table for Object F to determine which instance of Object E is the parent of which instance of Object F (this being evident from the presence of the specified instance of Object E in the Parent Object table rows corresponding to the specified instance of Object F).

In step 614, a representation of the reconstructed document is generated. In one embodiment, the representation may be displayed on a graphical display. In another embodiment, the representation may be fed to another software application for further processing and/or manipulation. In still another embodiment, the representation is fed to a terminal for display.

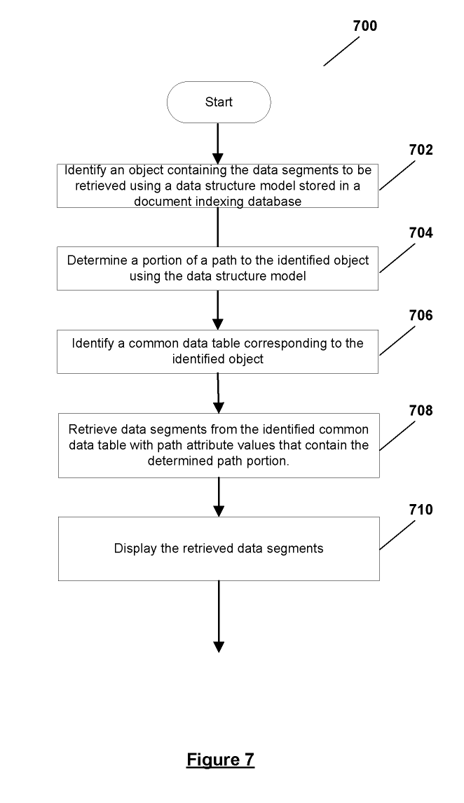

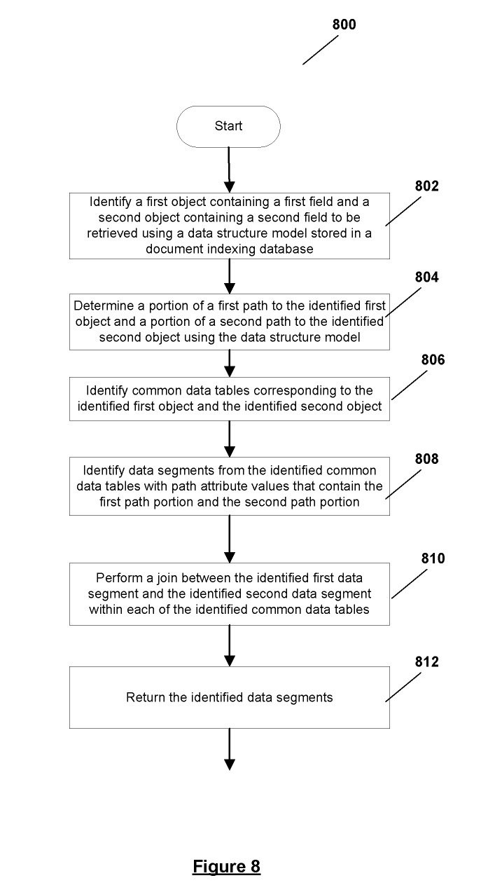

FIG. 7 is a flow chart illustrating an example process for retrieving data segments from a database, in accordance with one embodiment. Method 700 begins with step 702 where a data object containing the data segment to be retrieved is identified using a data structure model stored in a document indexing database. In one embodiment, the data structure model is a data container model. In another embodiment, the data structure model is an information model. For example, consider FIG. 3B. The physical document 318 represents a doctor's Consultation Note and Object “D” (328 and 330) is a blood pressure recording. If we retrieve the data structure model shown in FIG. 3A, we can determine that the blood pressure field corresponds to the object type D, and that the path to reach this object (in the context in which we have interest) is Document Type A\ Object C\ Object D. This then tells us which table to query in the data repository, and what constraint to apply to the path attribute of instances of Object “D” (328 and 330).

Method 700 proceeds on to step 704 where a portion of the path to the identified object is determined using the data structure model. This allows for a constraint to be introduced to a query function such that only data segments having a certain defined path segment is retrieved. For example, object C can occur within document type 1 contained within an object B, which is in turn contained within an object A, and C can also be contained within document type 2 contained within an object D. In this instance, the document type 1 path to object C would be: document type 1\ object A\ object B\ object C and the document type 2 path to object C would be: document type 2\ object D\ object C. A query function with a determined path portion of object A\ object B\ object C would return only data segments from instances of document type 1. The path is a trail that starts from the document type through the various sections and subsections containing the data segments that are being retrieved. Typically, the path would be identified using a data container model and/or a parent object table.

Moving on to step 706, the common data table corresponding to the identified data object is identified. This would be the location where the data segment would actually be stored.

In step 708, data segments from the identified common data table with path attribute values that contain the determined path portion are retrieved. Therefore, using the same example described for step 704, a path portion of object A\ object B would retrieve data segments from instances of document type 1, even though the path portion (i.e., object A\ object B) does not entirely match the path attribute (i.e., object A\ object B\ object C) of the data segments from instances of document type 1.

In step 710, the retrieved data segments are displayed. In one embodiment, the representation may be displayed on a graphical display. In another embodiment, the representation may be fed to another software application for further processing and/or manipulation. In still another embodiment, the representation is fed to a terminal for display.

FIG. 8 is a flow chart illustrating an example process for querying a database, in accordance with one embodiment. Method 800 begins with step 802 where a first data object containing a first field and a second data object containing a second field is identified using a data structure model stored in a document indexing database. In one embodiment, the data structure model is a data container model. In another embodiment, the data structure model is an information model. In still another embodiment, the data structure model is a parent object table for the data object.

Method 800 proceeds to step 804 where a portion of a first path to the identified first object and a portion of the second path to the identified second object is determined using the data structure model. As discussed above, this allows for a constraint to be introduced to a query function such that only data segments having a certain defined path segment is retrieved. For example, object C can occur within document type 1 contained within an object B, which is in turn contained within an object A, and C can also be contained within document type 2 contained within an object D. In this instance, the document type 1 path to object C would be: document type 1\ object A\ object B\ object C and the document type 2 path to object C would be: document type 2\ object D\ object C. A query function with a determined path portion of object A\ object B\ object C would return only data segments from instances of document type 1.

Method 800 continues on to step 806 where the common data tables corresponding to the first object and the second object are identified. This would be the location where the data segment would actually be stored.

Method 800 moves on to step 808 where data segments from the identified common data tables with path attribute values that contain the first path portion and the second path portion are identified. Therefore, using the same example described for step 804, a path portion of object A\ object B would retrieve data segments from instances of document type 1, even though the path portion (i.e., object A\ object B) does not entirely match the path attribute (i.e., object A\ object B\ object C) of the data segments from instances of document type 1. For example, consider FIG. 3A and FIG. 3B. If the goal of the query is to retrieve all objects subsumed by Object C, a constraint to path can be applied such that it contains the path portion Document Type A\Object C. This would result in the retrieval of Object D Instance 2 (not Instance 1), and all instances of Object E and Object F.

Method 800 proceeds to step 810 where a join is performed between the identified first data segment and the identified second data segment within each of the identified common data tables. For example, using FIGS. 3A and 3B to depict a join between instances of Object “F” (336 and 338) and instances of Object “D” (328 and 330), in one embodiment, the join can be performed by first constraining the instances of Object “D” (328 and 330) to those with path Document Type “A” 320\Object “C” 310 \Object “D” 312, and constrain the instances of Objects “E” (332 and 334) and “F” (336 and 338) to those containing the path fragment Document Type “A” 320\ Object “C” 310\ Object “E” 314. To do the join, all sets of (Object “D” 312, Object “E” 314, Object “F” 316) sharing as a common ancestor the same instance of Object “C” 310 would be returned. This can be done by inspecting the ordered list of foreign keys contained in the Parent Object tables for Objects “D” 312, “E” 314, and “F” 316 then requiring that the same instance ID to the Object “C” table is found in position 1 above the Object “D” instances (328 and 330), position 1 above the Object “E” instances (332 and 334), and position 2 above the Object “F” instances (336 and 338).

In another embodiment, knowing that the join occurs at Object C, firstly, all instances of Object “C” 310 with the path Document Type “A” 320 \Object “C” 310 are identified. Then, knowing that we want instances of Objects “D” 312, “E” 314 and “F” 316 that are descendant from Object “C” 310, find all instances of Objects “D” 312, “E” 314 and “F” 316 that list the instance ID of the specified instance of Object “C” 310 in their Parent Object tables.

It should be understood, however, that these are but just some embodiments of how a join can be executed and are not intended to be limiting. In practice, the steps and operations used to perform the join may differ depending on the particular construct of the database management system and the nature of the complex queries required to be executed on the particular database.

In step 812, the identified data segments are returned to the originator of the query.

The embodiments described herein, can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations that form part of the embodiments described herein are useful machine operations. The invention also relates to a device or an apparatus for performing these operations. The systems and methods described herein can be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

1. A computer implemented method for indexing a document on a database, comprising:
creating a unique identifier for the document;
adding an entry to a document instance table, wherein the entry includes the unique identifier and an attribute associated with the document;
identifying a document type for the document;
retrieving a data structure model associated with the identified document type from a document indexing database;
parsing the document into data segments that correspond to objects specified by the data structure model;
identifying common data tables associated with each of the specified objects, wherein the common data tables are stored in a common data repository; and
inserting the data segments into the common data tables associated with the specified objects that the data segments correspond to, wherein the data segments include the unique identifier for the document, a path to the specified object, and a unique object instance identifier.

2. The computer implemented method for indexing a document on a database, as recited in claim 1, further including:
for each inserted data segment, identifying a set of unique object instance identifiers corresponding to those specified objects that represent all specified objects on the path between the data segment and a root of the document.

3. The computer implemented method for indexing a document on a database, as recited in claim 2, further including:
inserting an identifier of the specified object into a parent object table associated with the specified object, wherein the identifier is arranged in a sequence corresponding to how the specified object is ordered in the path contained within the object corresponding to the inserted data segment.

4. The computer implemented method for indexing a document on a database, as recited in claim 1, wherein the data structure model is a data container model.

5. The computer implemented method for indexing a document on a database, as recited in claim 1, wherein the data structure model is an information model.

6. A computer implemented method for retrieving a document from a database, comprising:
locating the document on a document instance table using an attribute value associated with the document;
identifying a document type for the document;
retrieving a data structure model associated with the identified document type for the document;
identify common data tables corresponding to objects specified by the data structure model of the document;
retrieving data segments that share the same unique instance identifier as the document from the identified common data tables; and
reconstructing the document with the retrieved data segments, wherein the retrieved data segments are positioned within the document using a path attribute values of the retrieved data segments and the data structure model of the document.

7. The computer implemented method for retrieving a document from a database, as recited in claim 6, further including:
rendering the reconstructed document.

8. The computer implemented method for retrieving a document from a database, as recited in claim 6, further including:
using a parent object table to assist in positioning the retrieved data segment within the document.

9. The computer implemented method for retrieving a document from a database, as recited in claim 6, wherein the data structure model is a data container model.

10. The computer implemented method for retrieving a document from a database, as recited in claim 6, wherein the data structure model is an information model.

11. A computer implemented method for retrieving data segments from a database, comprising:
identifying an object containing the data segments to be retrieved using a data structure model stored in a document indexing database;
determining a portion of a path to the identified object using the data structure model;
identifying a common data table corresponding to the identified object; and
retrieving data segments from the identified common data table with path attribute values that contain the determined path portion.

12. The computer implemented method for retrieving data segments from a database, as recited in claim 11, further including:
using a parent object table in conjunction with the data structure model to identify the object containing the data segment.

13. The computer implemented method for retrieving data segments from a database, as recited in claim 11, wherein the data structure model is a data container model.

14. The computer implemented method for retrieving data segments from a database, as recited in claim 11, wherein the data structure model is an information model.

15. A computer implemented method for searching a database, comprising:
identifying a first object containing a first field and a second object containing a second field to be retrieved using a data structure model stored in a document indexing database;
determining a portion of a first path to the first object and a portion of a second path to the second object using the data structure model;
identifying common data tables corresponding to the identified first object and the identified second object;
identifying data segments from the identified common data tables with path attribute values that contain the first path portion and the second path portion;
performing a join between the identified first data segment and the identified second data segment within each of the identified common data tables; and
returning the identified data segments.

16. The computer implemented method for searching a database, as recited in claim 15, further including:
using a parent object table in conjunction with the data structure model to identify the first object and the second object.

17. The computer implemented method for searching a database, as recited in claim 15, wherein the data structure model is a data container model.

18. The computer implemented method for searching a database, as recited in claim 15, wherein the data structure model is an information model.

19. A database system, comprising:
a common data repository configured to store data in a common data table, wherein the common data table is associated with a data object,
a document indexing database configured to store a data structure model, wherein the data structure model is associated with a unique document type and is configured to facilitate retrieval of data stored in the common data table; and
a query engine communicatively linked to the document indexing database and the common data repository, the query engine configured to use the data structure model to retrieve data from the common data table.

20. The database system, as recited in claim 19, wherein the common data repository and document indexing database reside on the same computing device.

21. The database system, as recited in claim 19, wherein the common data repository and document indexing database reside in separate computing devices.

22. The database system, as recited in claim 19, wherein the common data repository resides in a plurality of distributed computing devices.

23. The database system, as recited in claim 19, wherein the data structure model is a data container model.

24. The database system, as recited in claim 19, wherein the data structure model is an information model.

25. The database system, as recited in claim 19, further including a client interface communicatively connected with the query engine.

26. The database system, as recited in claim 25, wherein the client interface is a software application configured to specify queries, insertions, updates and process the retrieved data.

27. The database system, as recited in claim 25, wherein the client interface is a terminal configured to display the retrieved data and facilitate the specification of queries, insertions and updates to the database system.
